(19) United States
(12) Patent Application Publication
(10) Pub. No.: US 2004/0199573 A1
(43) Pub. Date: Oct. 7, 2004

(54) System and method for remote diagnosis of distributed objects

(75) Inventors: Elia Schwartz, Nesher (IL); Mila Gorodetsky, Nesher (IL)

Correspondence Address: SYNNESTVEDT & LECHNER, LLP, 2600 ARAMARK TOWER, 1101 MARKET STREET, PHILADELPHIA, PA, 191072950

(73) Assignee: Predictive Systems Engineering, Ltd., Nesher (IL)

(21) Appl. No.: 10/697,481

(22) Filed: Oct. 30, 2003

Related U.S. Application Data
(60) Provisional application No. 60/422,787, filed on Oct. 31, 2002.

(51) Int. Cl. G05B 11/01; G05B 19/18

(52) U.S. Cl. 709/201; 709/217

(57) ABSTRACT

A system for diagnosing disorders of geographically distributed objects from a remote location. Data for a current condition are compared with predefined data patterns for known disorders to identify a statistically significant match indicating that the monitored object is presently experiencing the corresponding disorder. A critical disorder time is forecasted by determining when a threshold value will be reached using trend analysis of probabilities. A new disorder pattern preceding an observed disorder is added to the knowledge base for future reference. The knowledge base may be used to diagnose one object based on data collected from a similar object in a geographically distinct location. Diverse equipment may be conceptually decomposed into a small set of basic components, and equipment may be diagnosed by analyzing operation of its basic component(s). Informative data analysis procedures may be automatedly selected according to predetermined rules as a function of the monitored equipment's basic components.

### CROSS-REFERENCE TO RELATED APPLICATION

This application claims the benefit under 35 U.S.C. 119(e) of U.S. Provisional Patent Application No. 60/422,787, filed Oct. 31, 2002, the entire disclosure of which is hereby incorporated herein by reference.

### FIELD OF THE INVENTION

The present invention relates to the field of remote diagnosis of various kinds of distributed objects, such as diverse types of industrial and commercial equipment located in various geographical locations.

### BACKGROUND OF INVENTION

Existing predictive maintenance practice is mostly based on either: (1) the periodic inspection of the vibration of maintained equipment; or (2) on continuous condition monitoring by vibration sensors. Monitoring results are obtained in the form of spectrum plots that have to be manually analyzed to identify a problem. Such analysis is usually provided by vibration diagnostics specialists.

Typically, an industrial plant maintenance division relies solely upon its own resources and does not regularly communicate with outside institutions. Many ordinary plants cannot afford specialists capable of diagnosing the results of vibration inspections. Difficulties in the proper diagnosis of equipment failures and a lack of skilled specialists remain the main reasons why predictive maintenance is still not widely used.

Various Artificial Intelligence Expert Systems are well known in the art for automating failure diagnosis. However, such systems are not sophisticated enough to provide reliable diagnosis of failures of geographically distributed objects, such as general and industrial machinery, in various industrial locations.

One technique uses expert knowledge to define a set of diagnosis rules for identification of a specific fault. This approach, known for decades, does not provide reliable results because many machine faults have similar symptoms. The equipment operates in different conditions, can have various rates of wear, etc. Many times the failure symptoms are vague, and predefined, generalized rigid rules are insufficient for proper diagnosis. That is why known systems cannot properly or effectively recognize failure of distributed objects.

A number of other diagnosis methods have been proposed. One well-known method for failure diagnosis is based on the use of an Artificial Neural Network, ANN. To be trained, the ANN needs sets of data related to specific failures. In practice, such data is often unavailable. To overcome this difficulty, U.S. Pat. No. 5,623,579 discloses training the ANN on data obtained by the simulation of the monitored machine by physical modeling. Such a system may be workable for certain equipment. It was accomplished, for example, in the diagnosis of faults in a nuclear reactor, but is unsuitable for many of the diverse types of industrial equipment. Another type of ANN used for diagnosis purposes is Unsupervised ANN. Such ANN does not require preliminary knowledge of data related to a failure, but it can only distinguish between “good” and “not good” conditions without proper classification of the kind of a fault. An exemplary system is described in U.S. Pat. No. 5,576,632, “Neural Network auto-associator and method for induction motor monitoring.”

U.S. Pat. No. 5,642,296 discloses a method of diagnosis of malfunctions in semiconductor production equipment. Diagnosis techniques used in this project employ the Response Surface Models, RSM. The RSM methodology is based on preliminary provided experiments with the process. The process parameters are artificially changed and diagnosed system responses are registered. This method cannot be widely implemented for industrial machinery diagnosis because in most cases it is impossible or impractical to artificially simulate faults in industrial production floor equipment.

Another approach is described in U.S. Pat. No. 5,563,800, “Integrated model-based reasoning/Expert system for rotating machinery”. This patent relates to improving diagnosis of steam turbines by implementation of analytical finite element modeling. The results of fault modeling are compared with measurement results. The method may be suitable for research practice or for specific machinery, but is not practical for general applications and diverse types of equipment.

### SUMMARY OF THE INVENTION

The present invention provides a system and method for diagnosing mechanical and/or operational disorders of distributed objects from a remote location. Accordingly, the system is implemented via a network, such as the Internet or World Wide Web. Specifically, the system is well-suited to diagnose industrial and commercial equipment/machinery at a plurality of geographically distant locations. The present invention is also applicable to other types of distributed objects, for example, for medical diagnosis of disorders of the human body.

The system is computer-implemented via hardware and/or software to provide for automated diagnosis of monitored distributed objects. The system uses statistical evaluation techniques to compare a pattern of data for a current disorder condition with predefined patterns for data for known object disorders or failures; a statistically significant match with a certain predefined pattern is taken as an indication that the monitored equipment is presently experience the disorder/failure associated with that certain predefined pattern. In other words, the system statistically matches current monitored conditions against predefined and/or existing patterns of known failure conditions for monitored characteristics. As a result, the method produces the probabilities of compliance of the current condition pattern to predefined patterns; a high statistical correlation of current conditions to a predefined pattern for a known failure is reflected as a high probability that the system is currently experiencing the corresponding known failure.

The present invention also provides an on-line trend analysis of probabilities. Accordingly, the present invention provides for dynamic forecasting of future values for monitored conditions, e.g. for the failures/disorders having the greatest probabilities discussed above. More specifically, the time when the forecasted future values of the condition(s) having the greatest probability are expected to reach a threshold value, which is predetermined and stored in the diagnosis knowledge base, is considered as the time when the monitored failure is predicted to become critical.

The inventive method and system provides self-learning capabilities so that any new failure condition pattern, i.e. one preceding an observed failure but not already stored in the knowledge base, may be recognized as preceding such a failure and stored in the knowledge base. In this manner, the knowledge base grows with continued use, and subsequently such newly added failure condition patterns may be subsequently used to diagnose similar equipment. The knowledge base of failure patterns is maintained at a network-accessible server, such that information in the knowledge base may be accessed from various geographically diverse locations, and/or used to diagnose equipment/objects in diverse locations. In this manner, for example, equipment in one factory may be diagnosed using data gathered from failure of similar equipment in another factory. For example, when the calculated failure probabilities are relatively small, i.e. statistically insignificant, but the system nevertheless detects that some unknown failure actually exists, it registers, subject to an optional acknowledgment by a human expert, the current pattern of unknown failure in the system knowledge base and provides the upgrade of all diagnostics applications serving the same type of equipment, e.g. by communicating such new pattern to all diagnostic systems, or to all diagnostic systems monitoring equipment to which the new failure pattern may apply.

The present invention further provides for classification of expert-defined patterns of machine failures and other knowledge parameters. Industry uses very diverse types of rotation and reciprocation equipment such as, for example, vertical and horizontal centrifugal pumps, piston pumps, pumps with canned motors, fan pumps, vacuum pumps, compressors, mixers, fans, etc. Because of the diversity of such equipment, particularly across industries, it is difficult to ensure that the knowledge base is complete for all possible types of monitored equipment. Accordingly, the present invention provides for conceptual decomposition of diverse equipment to a relatively small set of basic components for diagnosis purposes. For example, a broad range of rotation and reciprocation equipment includes a relatively small number of basic components, such as rolling bearings, sleeve bearings, gears, induction motors, couplings, impellers, piston-cylinder pairs, etc. In other words, basic components common to all or many different types of equipment may be monitored in accordance with the present invention, and various expert-defined equipment disorder patterns are related to such basic components, rather than to the equipment as a whole, which allows for diagnosis of a broad range of diverse equipment as a result of monitoring and diagnosis of a relatively small set of basic components, for which a significant amount of data is likely to exist in the knowledge base. Similarly, parts of the human body can be identified and used for diagnostic purposes as basic components of the human body. An operator may manually specify which of the basic components are being monitored, or which of the basic components a particular piece of equipment has, and/or select which basic component of given equipment will be monitored. Alternatively, the system may maintain a database correlating individual pieces of equipment to any corresponding basic components that it includes, such that this step may be performed in an automated fashion upon identification of the equipment. Once such information has been provided to configure a local equipment monitoring/diagnosis system, pertinent disorder profiles for the identified components/objects may be downloaded/retrieved from a server storing such data for use by local or remote diagnostic systems. Any new failure profiles observed may be uploaded to the server for future use for diagnosis of the same equipment, same component, or similar equipment/components in different locations. Knowledge about a failure pattern for a certain component in a certain type of equipment may be used to diagnose other equipment of a different type, provided that such other equipment has an identical or similar component.

The present invention also provides knowledge driven signal processing. In other words, signal analysis procedures, needed for a specific diagnosis application, are selected automatically by an Expert System as a function of predetermined rules that govern selection of such signal analysis procedures as a function of the basic components of the monitored equipment. Examples of suitable signal analysis procedures include Fast Fourier Transfer (FFT), Hilbert transforming, Cepstrum, statistical analysis and others. The choice of the specific procedures for specific monitored equipment depends on the purpose and subject of the signal processing, the choice being automatedly governed by rules.

In view of the relatively large number of parameters involved, it is difficult to get meaningful diagnostic information from mere signal processing. For example, an exemplary frequency domain spectrum for machine vibration will include thousands of amplitude/frequency pairs of parameters. For effective monitoring, such data needs to be decomposed and informative parameters, referred to herein as diagnostics indicators, have to be selected. The present invention provides the framework for such automated diagnosis wherein an automatic selection of diagnostic indicators is provided by an Expert System's rules, which identify certain informative diagnostic indicators as a function of the basic components of the currently monitored equipment/objects.

The present invention provides a system including a primary computer providing data acquisition, to gather data via sensors, etc. from the monitored equipment, and signal processing, to analyze gathered data, functions. The system further includes a secondary computer connected to the primary computer and providing trend analysis for diagnostics indicators selected via rules at the secondary computer, creation of data patterns reflecting current disorders, and for comparing the current disorder patterns to pre-existing patterns for known failure to diagnose the monitored objects. The system further includes a central server supporting operation of the whole system and an Internet site providing on-line access to the data accumulated in the secondary computers and central server. The secondary computer includes an expert system that may include a rules domain that may include signal processing rules, rules for selecting a diagnostics indicator, a trend analysis rule domain for predicting a time of reaching a critical threshold value for a monitored parameter based on a trend formed from collected data, failure confidence rules for comparing current failure patterns to pre-existing failure patterns to determined correlations and probabilities of various failures, archiving rules for storing data, report generation rules for generating reports of data, and data transmitting rules. The secondary computer also includes a knowledge base consisting of: data acquisition settings for each type of monitored equipment, a database of basic components as they relate to various pieces of equipment, a database of relevant diagnostic indicators for various machine components, base line model parameters indicating normal operation, a database of critical thresholds indicative of failures for various monitored parameters, and a database of failure patterns correlating monitored parameters with known failure conditions.

### BRIEF DESCRIPTION OF THE DRAWINGS

FIGS. 1a and 1b show an exemplary configuration of a system for remote diagnosis of distributed objects in accordance with the present invention;

FIG. 2 shows an exemplary Primary Computer Data Acquisition and Signal processing Block Diagram;

FIG. 3 shows an exemplary Remote Diagnostics System Structure;

FIG. 4 shows an exemplary Expert system Structure;

FIG. 5 shows an exemplary Batch Processing Data Flow;

FIG. 6 shows an exemplary Diagnostics Indicators Processing Data Flow;

FIG. 7 illustrates an exemplary Base Line Model creation;

FIG. 8 shows an exemplary Trend Analysis Data Flow;

FIG. 9 shows an exemplary Failure/Disorder Classification Data Flow; and

FIG. 10 illustrates an exemplary expected failure/disorder Time Prediction.

### DETAILED DESCRIPTION OF THE PREFERRED EMBODIMENT

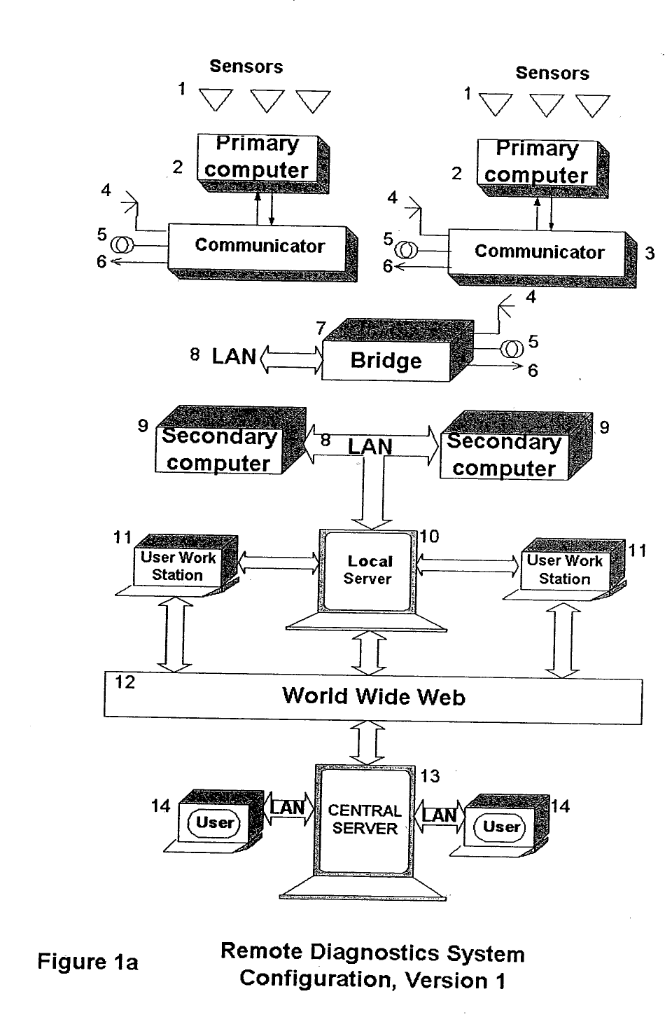

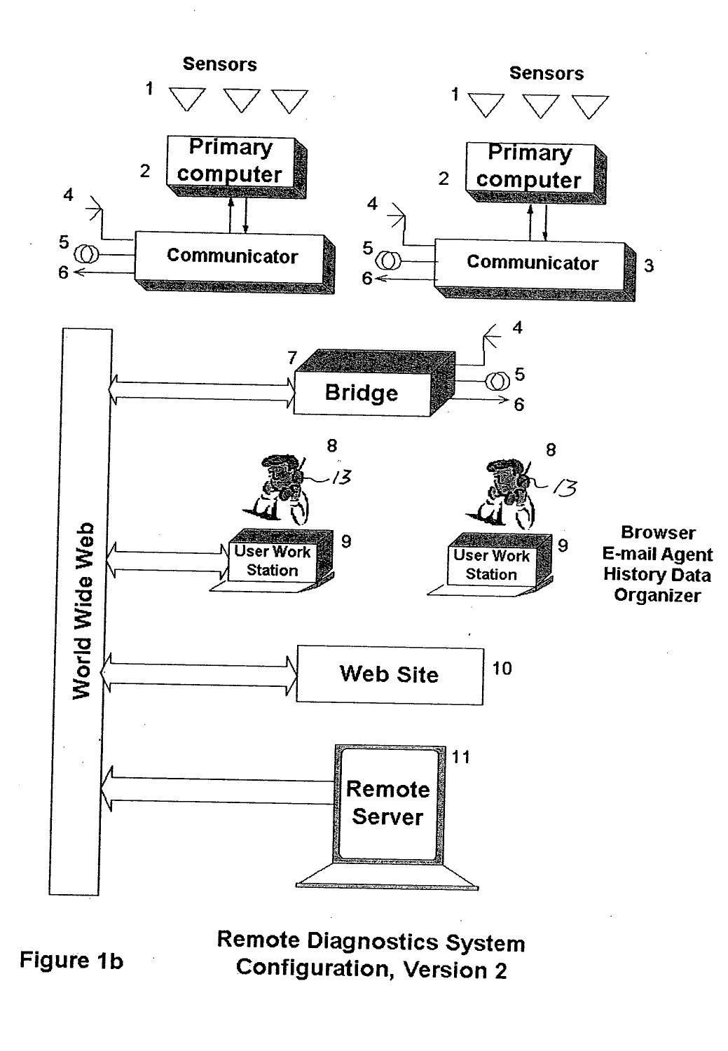

FIGS. 1a and 1b show two exemplary alternative configurations of a system for providing remote diagnosis of distributed objects in accordance with the present invention.

The system shown in the FIG. 1a includes sensors and transducers 1 for gathering data from the objects desired to be monitored that may be used to recognize and/or predict failures, primary computers 2 providing signal data acquisition from the sensors and transducers 1 and signal processing of such signals; communication facility 3 connecting the primary computer 2 with communication bridge 7 by suitable communication means such as, for example, wireless data communication 4, power line communication 5 or by cable, 6. The bridge 7 provides communication to the secondary computers 9 by a network such as local area network, LAN, 8. The secondary computer 9 receives information from secondary bridge 7 and processes such information to provide the trend analysis of said signals and failure diagnostics. The secondary computer 9 transmits data to the local intranet server (servers) 10. User work stations 11 are connected to the local sever 10 by a LAN or other network.

FIG. 1b illustrates an alternative system wherein signal processing is provided by primary computers 2 located near monitored objects, and wherein further data processing is performed by the remote secondary computer 9. Communicator 3, bridge 7 and World Wide Web 12 provide for data communication from primary computers 2 to the secondary computers 9. The system is managed by the system's central server 11.

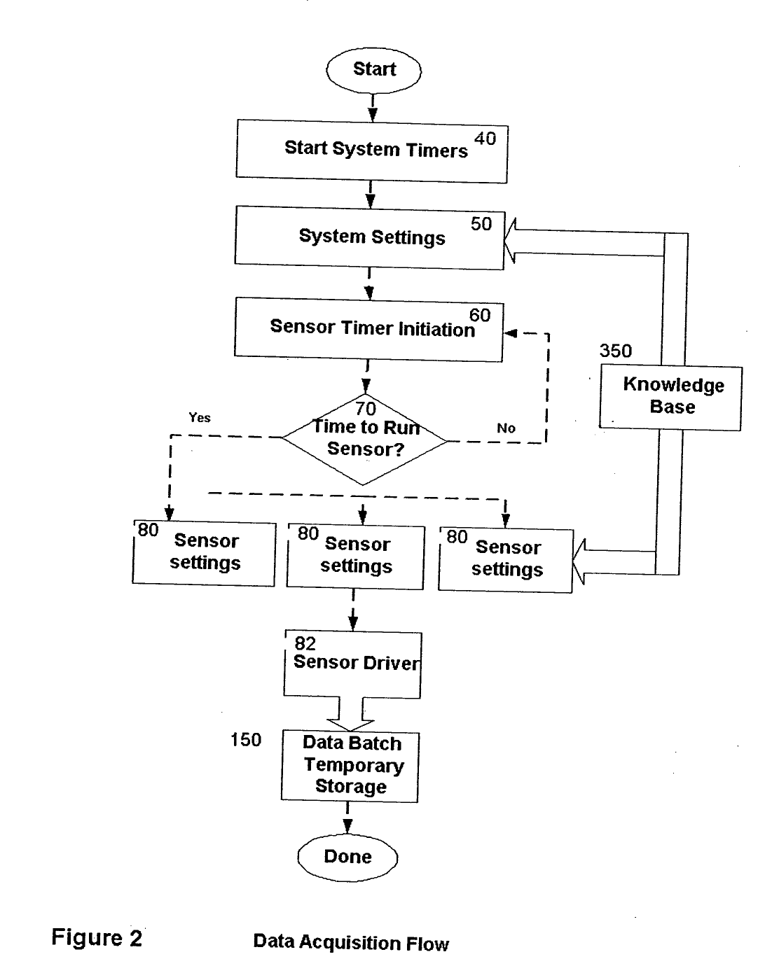

The system has at least two principal information data flows, the first of which is information data flow initiated by a user. Such information relates to the current conditions of the monitored objects. Accordingly, the user may visually inspect a display of information relating to the user's monitored equipment, etc. To support this information delivery, the system provides a user-accessible website 10 (FIG. 2) that is displayable by commercially available Web browsers. Upon receiving a user's request, the website 10 provides a connection to a related secondary computer and retrieves the requested information in the form of data, plots, tables, reports, etc. Such information is then displayed to the requesting user via the website.

The second of these information data flows is automatically initiated by the system. Such data flows provide warnings related to any disorders and/or failures in the monitored objects. This information is sent to the specified users=work stations (secondary computers 9, FIG. 2) by email or/and by voice to the users=cell phones 13 (FIG. 2). The data communication between the secondary computers and cell phone network is provided by the modems 14.

FIG. 1a illustrates an exemplary diagnostic system servicing objects relating to an organization having its own intranet facilities. FIG. 1b illustrates an exemplary system for servicing objects through World Wide Web network.

The present invention may be implemented with a computerized system including diagnostics sensors permanently installed on the monitored objects. In the case of machine diagnostics, such sensors may include vibration accelerometers, acoustical sensors, motor current and voltage sensors, torsion vibration sensors, etc. In the case of medical diagnostics, such sensors may include blood pressure meters, pulse meters, cardiographs, etc.

The system further includes primary computers 2, as shown in FIG. 2, located near monitored objects for gathering data from the sensors. Accordingly, the role of the primary computers is to provide the data acquisition and signal processing. The present invention provides a high degree of flexibility for the primary computer data acquisition and signal processing procedures that are specific for a type of sensor and for a structure of monitored objects. Any suitable sensors and data collection techniques for a desired application may be used.

FIG. 2 illustrates the data acquisition performed on the primary computers 2 of FIG. 1. The Data Acquisition software module of the primary computer(s) 2 reads the Data Acquisition Configuration settings (block 50, FIG. 2 from the system's knowledge base 350, which include monitored-object specific knowledge, which is resident at the secondary computer 9, and general object type knowledge, which is resident at the central server. These settings define the entity of sensors operating on every piece of monitored objects/equipment. As shown at step 60, FIG. 2, the system initiates sensor timers. The real time engine 70, FIG. 2, of the secondary computer 9, runs the data acquisition according to data acquisition and sensor setting information retrieved from the secondary computer's knowledge base 350. The sensor settings, block 80, FIG. 2, outline the sensor operation format such as an operation mode flags (steady, start up, etc), the values of sensor time series length, the interval between time series, provides the preliminary sensors diagnostics, initiates software drivers, specific for a type of the sensor and for the hardware providing the data acquisition. Sensor data is recorded and stored in temporary data storage (memory) on the secondary computer 9.

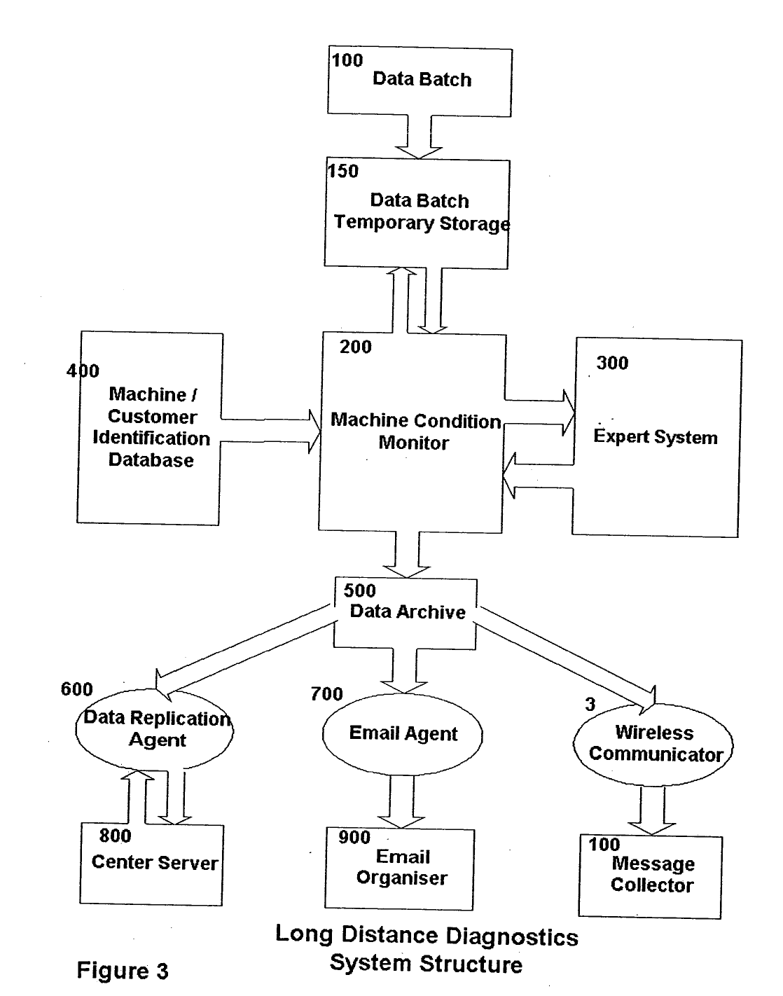

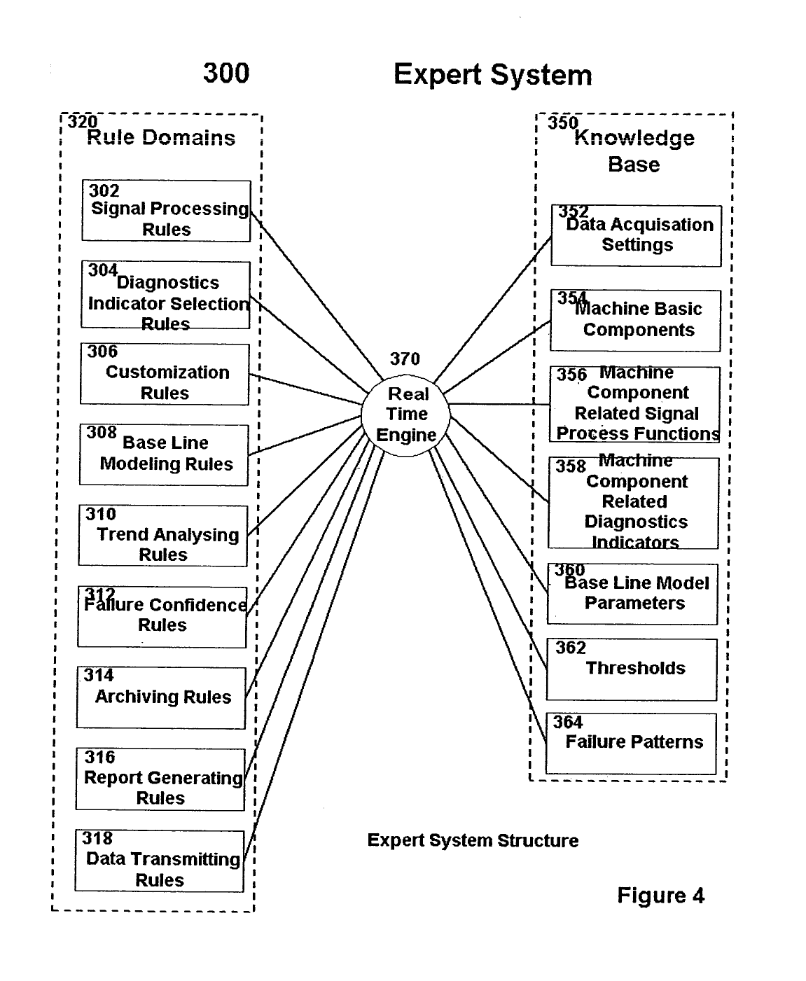

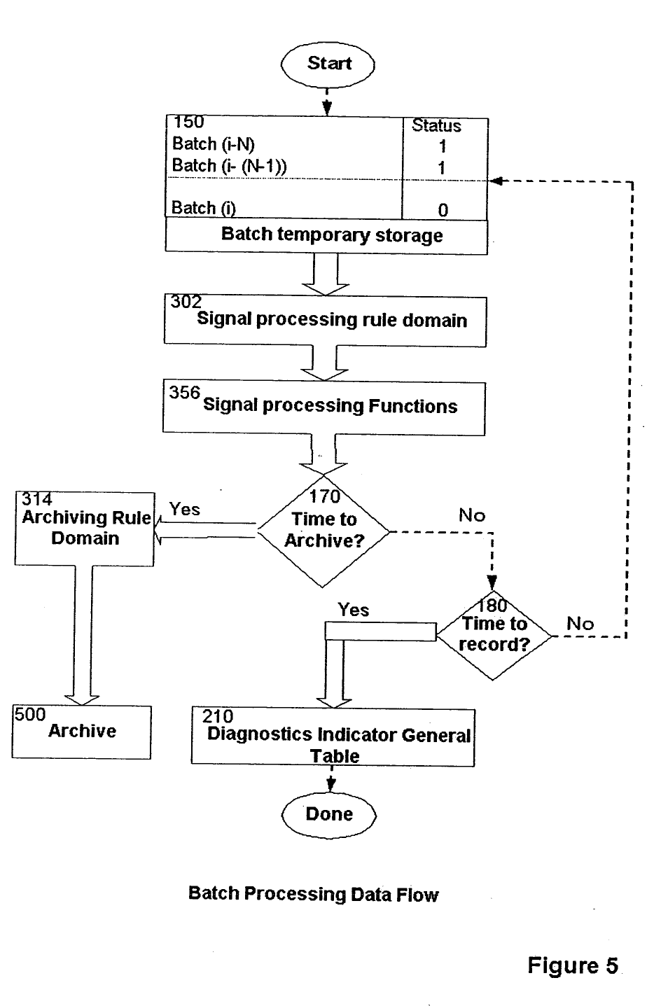

The system also includes secondary computers 9 connected with a number of primary computers for processing the data gathered by the primary computers 2. The role of the secondary computers, as shown in FIG. 3, is to provide monitoring and failure/disorder diagnosis of the monitored (distributed) objects. The secondary computer 9 may include temporary data storage 150 (e.g. volatile memory and/or hard drive storage space), and a data archive 500 for storing collected and/or analyzed data. The temporary data storage 150 and permanent data archive 500, FIG. 3, constitute the secondary computer data storage. The data storing process is governed by the rules of the knowledge base 350. The temporary data storage contains all data batches for some period of time defined by the archiving rule domain 314, FIG. 4. The data batch temporary storage is periodically cleaned. The cleaning of temporary data storage is controlled by the archiving rule domain according to a load on the system. The archive data storage contains the time related samples of the full batches including sensors data, spectra, fractals, etc., and compressed values of diagnostics indicators. Data compression is carried out according to rules of the archiving rule domain 314. The archiving of a diagnotic indicator is usually provided if deviation of its new value from the stored one is greater than that defined by the knowledge base 350.

The secondary computers 9 further include a condition monitor 200 for monitoring the current condition of the monitored objects. The condition monitor 200 executes further data processing, as commanded by an expert system 300, FIG. 4, as discussed in greater detail below. The results of the condition monitor's 200 operation are stored in the system archive 500, FIG. 3. The secondary computers 9 further includes a disorder/failure analyzer 450 for interpreting/analyzing collected data and comparing such data to data patterns for known failures, instrumentation and object identification database 400, an email agent 700, and a data base replication agent 600. The email agent 700, the data replication agent 600 and the wireless communicator 3, FIG. 1 provide for further data transmission to the central server 800, an Internet site and to user workstations, personal data assistants, cell phones, etc. Communication facilities are provided to connect the primary and secondary computers 2, 9 by power line communication, wireless communication or any other suitable type of communication. The central server 11 supports operation of the secondary computers by storing a knowledge base for general types of monitorable objects, which may be referenced by the secondary computers when monitoring a specific object. User workstations and cell phones are connected with the secondary computers 9 and central server 11 by Internet or any other suitable communications network.

The expert system 300 regulates the whole system's performance. The general structure of the expert system is illustrated in FIG. 4. As shown in FIG. 4, the expert system 300 has two main components: rule domains 320 and knowledge base 350. A rule domain is a set of rules commanding a specific process, such as, for example, signal processing, Diagnostic Indicator selection, trend analysis, data archiving, data transmitting, etc.

The knowledge base 350 structure contains information related to the basic components of the distributed objects (e.g., gears, etc.), signal processing procedures for analyzing failure patterns, base line modeling parameters for establishing a profile of normal operating conditions, a database of threshold values for critical operating parameters, data acquisition settings for various sensors, etc. The expert system 300 selects the rules defining settings related to a type of sensor and monitored objects structure components. The expert system's decisions are dynamic and vary according to current signal processing results. Settings are transferred to the primary computers 2 from the secondary computers 9 before data acquisition and signal processing sessions. The results of data acquisition and signal processing are concentrated in the data entities (“batches”) FIG. 2 that are generated by the primary computers and recorded in the data batch temporary storage 150 located on a secondary computer.

The expert system's performance can be illustrated in an example of batch data processing. The signal processing rule domain checks the status of a batch. If the batch is still not processed it evokes signal processing functions that are implemented according to the type of sensor (in the case of machine diagnostics it can be vibration, acoustical, motor current sensors, etc.) and to the distributed object basic components linked to the sensor. In the case of machinery diagnostics, the basic components mean the machine's structural elements such as bearings, gears, etc. that are common to equipment of many types, brands and models. As it was described above, the method of the present invention relates to a monitored distributed object as a collection of basic components wherein each of these components requests some specific signal processing functions.

Upon activation, the signal processing rule domain calls for the data processing functions defined by the domain rules. These functions process the batch data, record results of data processing in the same batch and change batch status flags. The functions initiated by signal processing rule domains include: functions preparing data for processing; and signal analysis functions such as Fast Fourier Transform (turning the measured signal time series (waveforms) such as shown, for example, in FIG. 12 into the Frequency Domain spectra), fractal building (providing creation of an image visualizing the health status of the monitored equipment), Hilbert Transform (providing the enveloping of the fractals and spectra), Cepstrum analysis functions, etc.

The algorithms of the above-mentioned signal processing procedures are known in the art. A discussion of the fractal building is disclosed in U.S. patent application Ser. No. 60/297,380 (Attorney Docket No. P24,730 USA), filed Jun. 11, 2001 and U.S. patent application Ser. No. 10/166,903 (Attorney Docket No. P24,730-A USA, filed June 11, 2002), the entire disclosures of both of which are hereby incorporated herein by reference.

The next step of signal processing commanded by a signal processing rule domain relates to the decomposition of transform results such as spectra, envelopes, fractals and others, obtained by the first set of signal processing functions.

As it was mentioned above, spectra, envelopes, fractals and other entities contain thousands of parameters. The purpose of logical decomposition of relatively complex, diverse machinery into a relatively small set of relatively simple mechanisms is to detect the most informative parameters considered most valuable for the failure diagnostics. These parameters are referred to herein as Diagnostic Indicators. For example, such Diagnostic Indicators include: Spectra Overall, Band Maximum amplitudes, Side Bands Amplitudes and Frequencies, Band Power Spectrum Densities, Resonance Frequencies, Peak factor, Noise Centrum coordinates, Cestrum period and Multitude values, Kurtosis values, fractal envelope parameters, etc. The specific set of Diagnosis Indicators used for analysis of a particular monitored object depends upon the identity of the basic components of that particular monitored object, and the type of diagnostic sensors/transducers used. These parameters are known to those skilled in the art.

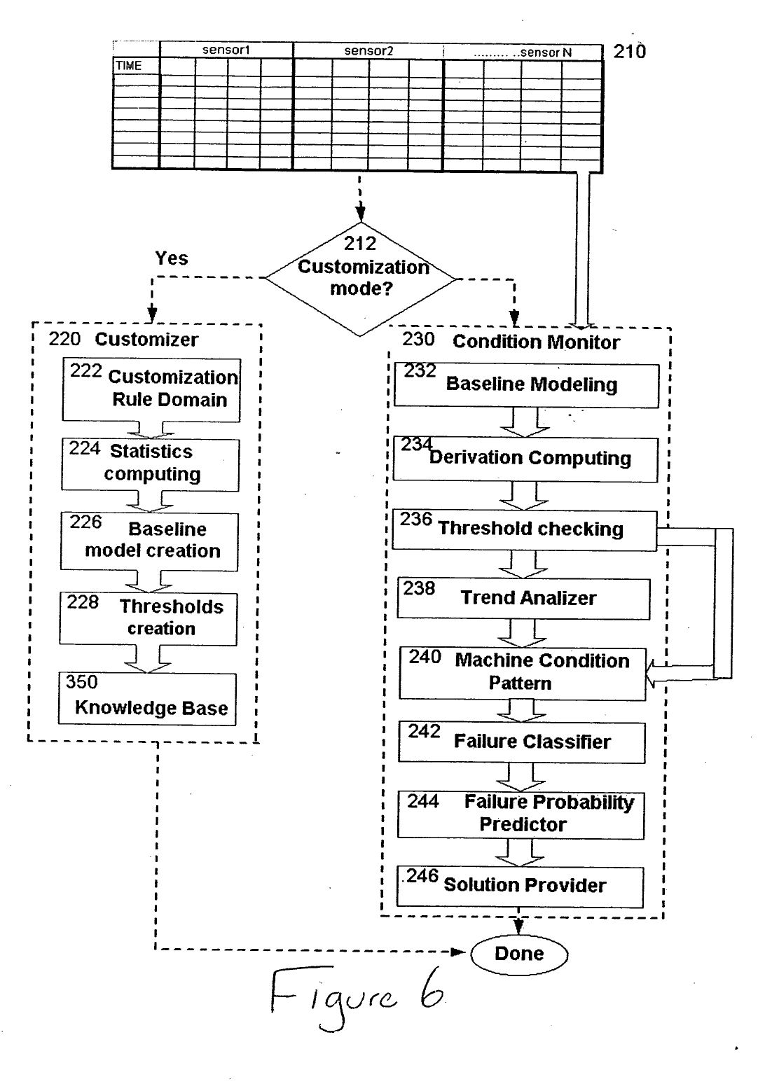

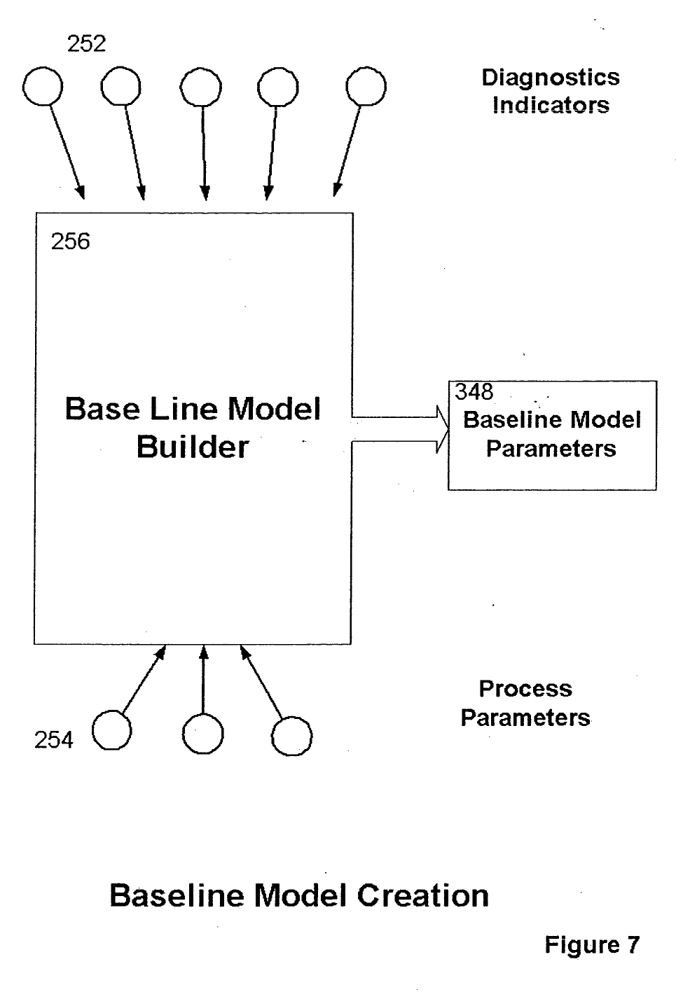

The present invention provides for automatic selection of Diagnostic Indicators that will be most informative for diagnosis of failures/disruptions in the specific basic components incorporated in the monitored piece of equipment. As illustrated in FIG. 6, the data batch signal processing results in the archiving of signal processing results and/or creation of the time related Diagnostic Indicators general table 210, FIG. 6, wherein every table row provides a snapshot of Diagnostic Indicators and related process parameters or their means from all batches recorded for a specific period of time.

A further data processing flow chart is illustrated in FIG. 6; It is executed in two modes: customization mode, module 220, and monitoring mode, module 230. In the customization mode, the system provides for computation of the data statistics that will be used for further data processing, including calculation of time series means, standard deviations, Kurtosis values, etc.

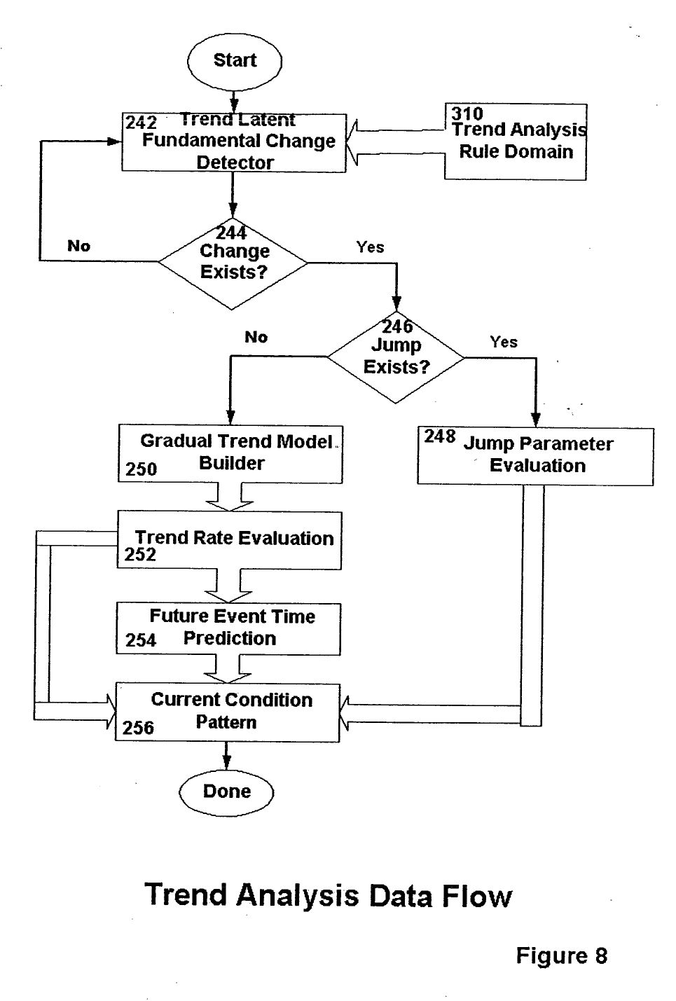

The next step of customization includes creation of a base line model, block 226, FIG. 6, that describes the monitored machine's performance at the normal conditions related to the beginning of the remote diagnostics systems' operation. Typical model creation is shown in the FIG. 8. The base line model provides a correlation of the monitored object's operating parameters. In the case of machine monitoring, it can be a number of revolutions, a motor power, a machine capacity, process pressures and temperatures, etc. and Diagnostic Indicator values stored in the Diagnostic Indicators general table. The modeling is provided over a period of time specific for an application. The modeling rule domain 308 defines the modeling parameters such as the specification of process parameters and diagnostics indicators, accuracy, etc. As a modeling technology, Artificial Neural Networks and Regression Modeling, both well known in the art, may be used by the system for this purpose. The specific tool/modeling technology to be used is selected by the signal processing rule domain as a function of the object's structure and its operation.

The system customization includes evaluation of thresholds, block 228, FIG. 6, of diagnostic parameters. The system evaluates the standard deviations of diagnostic parameters typical for normal performance of the monitored objects. The statistical thresholds related to abnormalities are established as those values that differ by three standard deviations or more from the normal values of the diagnostics parameters. The obtained values from the monitored object-specific base line model (normal operating condition) parameters and threshold values (indicating a fault condition) are stored in the knowledge base 350, FIG. 6.

Other functionality of the customization mode relates to the statistical classification of the monitored object's failure/disorders patterns, as discussed further below.

As shown in FIG. 6, module 230 illustrates system operation in monitoring mode. This module uses the base line (normal operation) condition model obtained in the customization mode, block 220, and simulates baseline machine performance under current conditions, block 232, FIG. 6. In other words, the model obtained under baseline conditions is compared to current operation reflected by the measured values with initial conditions reflected by the model. For example, the model is customized for particular monitored machinery by substituting the corresponding value for the monitored machinery's capacity. Some spectrum amplitude is obtained that relates to simulation of the base line conditions and is compared with the same parameter measured presently. The deviation serves as a sign of status. Further, it performs deviation computing by calculating the current variations from base line machine performance, block 234. At the next step, block 236, it compares these variation values with thresholds defined in the customization mode, block 228, FIG. 6. If any Diagnostic Indicator value reaches the predetermined threshold, the system records this event to current machine condition pattern 240, FIG. 6, and stores them in the Diagnostic Indicators general table 210, FIG. 6.

The data flow of the trend analyzer is shown in FIG. 8. The functionality of the trend analyzer includes trend latent fundamental change detector, block 242, FIG. 8. The purpose of this block is to track trend behavior for detecting new fundamental (essential) changes. For example, a change may be considered fundamental if a new trend value increases or decreases the sliding window mean value more than three standard deviations and this change takes place in the time defined by trend analyzing rules, block 316. The trend analyzer block operates according to predetermined rules established and stored as part of the trend analysis rule domain, block 308, FIG. 4.

If a change is detected, the trend analyzer determines the nature of the change; such as a sudden change (a jump) or a gradual one. Block 248, FIG. 8 evaluates the jump level and block 250 builds an analytical model of a new gradual trend. Block 254, FIG. 8 provides for trend extrapolation that is used to predict future behavior by using the trend model obtained in block 250. Block 252 provides trend rate evaluation. The rate value as well as the jump level value are recorded in the current condition pattern, block 256, FIG. 8, i.e. condition pattern 240, FIG. 6, which contains the history of a failure's development. For trend modeling and extrapolation the method uses techniques well known in the art, such as polynomial regression modeling.

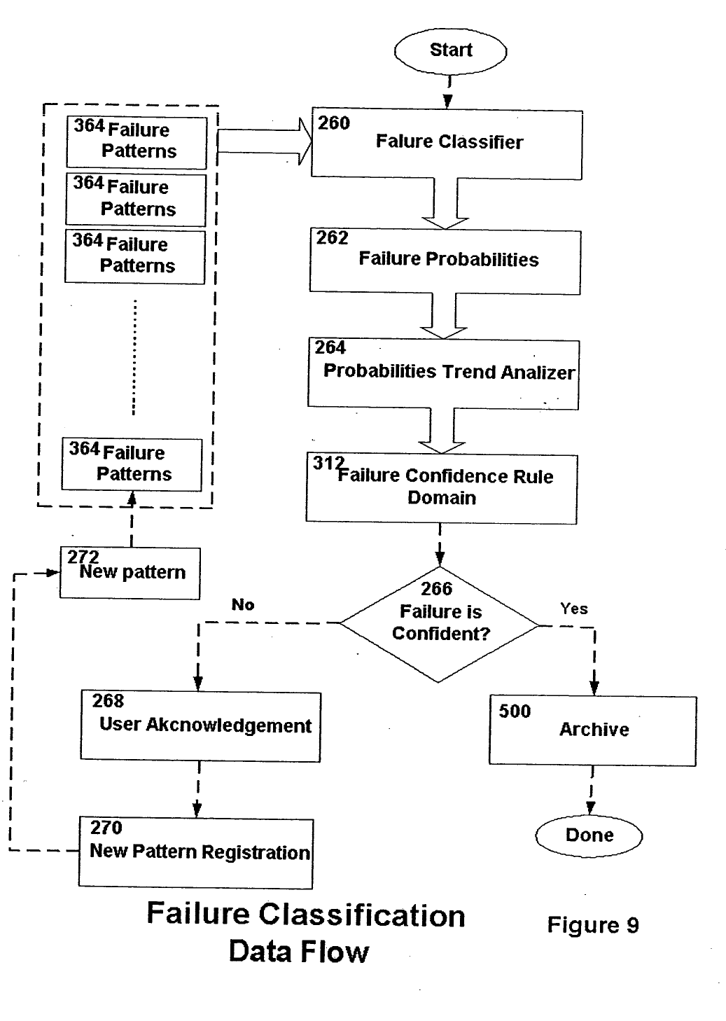

The current condition pattern 256 is used further by the statistical failure classifier 260, a block diagram of which is shown in FIG. 9, as discussed further below.

The disorder/failure analyzer 450, FIG. 3 processes a current disorder/failure pattern further. The block diagram of the disorder/failure analyzer 450 is shown in FIG. 9. It includes a failure/disorders classifier 260 that compares the current condition pattern 256 with the set of predefined failure patterns 364, stored in the knowledge base 350, FIGS. 4, 9.

It is unlikely that the specific failure/disorders statistical symptoms will match exactly the predefined failure patterns. The difference between them could be caused by expert knowledge limitations, the peculiarity of the specific object, object operation mode, the influence of other objects on the monitored one, etc. So it may be difficult to provide a completely accurate diagnosis of a distributed object's failure/disorder.

To diagnose such distributed objects, the present invention employs the statistical evaluation of closeness of a current list of symptoms defined in the current condition pattern 256 to an expert-defined set 364, FIG. 4.

The description of the technique of this evaluation follows:

The expert defined pattern vector of failure (I) can be presented as:

Xᵢ₁;Xᵢ₂; . . . Xᵢₙ

When Xᵢ₁;Xᵢ₂; . . . Xᵢₙ are numeric values of failure symptoms.

The mean value of the expert defined pattern can be calculated as:

$$M ( i ) = \frac{{x}_{i1} + {x}_{i2} + … + {x}_{in}}{n}$$

The matrix of predefined failure symptoms mean values, Mₘₑₐₙ, can be computed as follows:

Mₘₑₐₙ(ij)=M(i)

The vectors of all failures can be presented as the matrix X

X=∥xᵢⱼ∥

Here: 1≦i≦p,

p—number of failure patterns;

1≦j≦n,

n—number of symptoms in every pattern.

The centralized form of this matrix can be obtained as

X_{c}=X−Mₘₑₐₙ

The related covariant matrix is obtained as:

Covar=(X_{c}′X_{c})/n.

According to the method of the present invention, the Covariant matrix represents the set of expert defined failure patterns.

The determinant of the covariant matrix |Covar| can be calculated by the method well known in the art.

For example, consider a current symptom pattern designated as a vector Y.

The probability of Vector Y to represent one of the previously defined failures with pattern mean value M can be calculated as”

$$P r = a {ⅇ}^{\frac{- b}{2}} ,$$

Here:

a=(2π)^{p/2}|Covar|^{1/2} and

b=(Y−M)Covar⁻¹(Y−M),

The M matrix for known failure patterns are obtained in the customization module, block 220, FIG. 6.

The above-described logic of failure classification is implemented in the failure classifier 242, FIG. 6, which determines statistical similarity between the current condition pattern and various different predefined failure patterns.

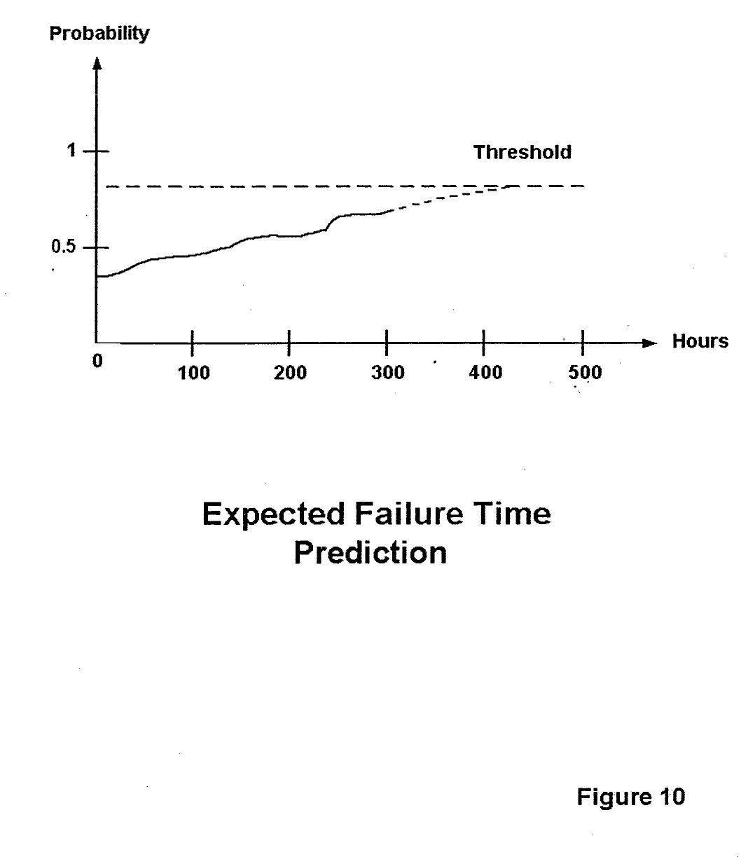

The system computes the probabilities of all predefined patterns to represent the current situation and to track the trends of several largest probabilities, block 264, FIG. 9. Block 264 provides the trend analysis of these probability trends and predicts when some probability will reach a threshold defined by the failure confidence rule domain 312. An example of probabilities trend analyzer performance is shown in FIG. 10.

The system considers the time when the probability of some failure is expected to reach a predetermined threshold as the time of a future failure. If the probabilities of the whole system known failure patterns are very low, e.g. below a predetermined threshold, then the system cannot recognize the current condition. This means that the system knowledge is not sufficient and has to be broadened. Block 312, FIG. 9 makes the appropriate decision.

The sequence of system actions in this case is as follows: the secondary computer sends a report to users with a message that an unidentifiable failure has been detected; the secondary computer data replication agent provides a replication of the unidentifiable failure pattern to the central server; upon an authorized user's acknowledgment, the current pattern is registered as a new failure pattern, block 270, FIG. 9; the name and ID of the new failure pattern is entered by an authorized user; and the central server upgrades related knowledge bases on all secondary computers, block 292, FIG. 9, so the previously unidentifiable failure may be identified when it reoccurs in the future.

If a new failure pattern is added to the matrix X, the Covar and |Covar| have to be recomputed.

The diagnosis results may be delivered to a user by an email agent 700, FIG. 3, such as the commercially available Microsoft Outlook software program. This program, when evoked by the data transmission rule domain, block 318, sends e-mail messages according to a user address database that is a part of the machine/customer identification database, 400, FIG. 3 stored on the secondary computer.

A list of predefined messages for distribution via the email agent is stored in the system's knowledge base 350. The choice of a specific message is made automatically by the report generating rules, block 316, FIG. 4, according to user responsibilities, application definitions, the severity of an expected system failure, etc. The reports attached to an email may illustrate the failure growth history, last signal processing plots, animated pictures of a monitored machine, etc.

According to the present invention, the main functionality of the system's central server is to support the operation of the diagnostics communication network. Accordingly, the central server's functionality includes: replicating of the secondary computers data bases; storing the central knowledge base related to the different types of rotary (or other) equipment components; automatic supervising of the primary and secondary computers' operation; and automatic update of the knowledge bases resulting from the self learning capabilities of the system.

As a framework for the described system, any relational data base software such as, for example, Oracle of Oracle Inc. or Microsoft SQL Server of Microsoft, Inc., may be used.

As data replication agent, the system employs the commercially available facilities of the Microsoft SQL Server Data Base package or in the Oracle software package.

Accordingly, a system for remote diagnosis of distributed objects in accordance with the present invention may include a plurality of diagnostics sensors and transducers permanently installed on the monitored objects, a plurality of primary computers performing the data acquisition and signal processing located near monitored objects and connected to said sensors; and a secondary computer or computer net worth for fault or disorder detection, diagnosing and reporting connected to said primary computers, a diagnostics center computer connected to said secondary computers, Internet Site and user work stations or/and Cell Phones connected to the secondary and diagnostics center computer.

The system primary computer may also be reconfigured by an expert system placed on the secondary computer. The secondary computer may also include: an Expert System for knowledge-based signal analysis; a machine condition monitor for automatic monitoring of distributed objects; Diagnostics Data temporary storage for use in data processing; a Machine/Customer Identification Data Base for storing and identifying diagnosis results; a Data Archive for creation of histories of object performance; and an e-mail agent for sending diagnosis reports.

The system can also include a diagnostics center computer containing: replication of all databases and expert systems placed on the secondary computers; a replication agent commanding data replication processes; and a general information database supporting the system operation.

The system can also include an Internet site providing a current diagnostics information related to the monitored distributed objects.

The expert system can Include rule domains, a knowledge base and a real time engine that are responsible for secondary computer operation. The system of the secondary computer may also include rule domains containing: a signal processing rule domain, containing rules that activate the signal processing functions wherein every rule domain is specific for a basic component of monitored object (objects); and a Diagnostics Indicator selection rule domain, including rules for selection of the most informative diagnostics indicators; a customization rule domain, containing rules commanding customization mode system operation; a base line modeling rule domain, containing rules commanding selection of a type of base line model, model structure and parameters; a failure confidence rule domain for evaluating probabilities of a predefined failure pattern(s) to represent the current situation; an archiving rule domain providing condition for data archiving; a report generation rule domain, supporting automatic generation of reports; and a data transmitting rule domain, supporting on-condition data and report transmitting.

The knowledge base may include: data acquisition settings, providing data acquisition software module with data acquisition parameters such as for example, signal filtration parameters, lengths of data time series, etc.; a list of monitored objects basic components, including identifiers of basic components specific for the monitored objects; signal processing functions, executing the signal processing specific for a basic component; base line model parameters, describing the type of the model and proving information for the model tuning; Diagnostics Indicators thresholds, pointing on abnormalities in the monitored objects; and failure symptom patterns, providing signatures of possible failures.

The expert system rule domains can be related to monitored distributed objects components and to sensors permanently installed on the monitored objects.

The system records the values of the Diagnosis Indicators and Process Parameters related to some period of time in a data base table wherein the diagnostics system resolution is restricted by this time period and creates by this a dynamic pattern of a current disorder.

The system generates a dynamic pattern of a current disorder.

The system may include a Customizer providing on line statistical evaluation and modeling of time series of Diagnostics Indicators and Process parameters in the normal operation conditions and performs the automatic evaluation of diagnostics indicator threshold values.

The system may include a Statistical Failure Classifier comparing a current machine condition disorder pattern with predefined failure symptom patterns to provide disorder/failure pattern recognition.

The system Statistical Failure Classifier may generate probabilities of predefined failure/disorder symptom patterns to represent the current object failure/disorder pattern.

The system may also include failure probabilities trend analyzer, which provides dynamic modeling of probability time series and uses this dynamic model to forecast their future expected values.

The system may also Include self-learning capabilities by supporting the automatic creation of new failure symptom patterns when probabilities of the predetermined failure patterns to represent the current disorder are low.

The system may also upgrade automatically the related object type knowledge bases on all secondary computers supported by the system diagnosis central computer.

The system may be combined with a system for Phase Angle Machine Diagnostics Technology, PAMDT. PAMDT uses motor current phase angle sensors to gather critical information about the health of rotary equipment driven by the induction motors. Phase angle sensors provide a better signal than motor current sensors because they reduce the “noise” (extraneous signals) in power supply lines.

A dual function vibration-acoustic sensor may be combined in one sensor body. This product makes it possible to measure from 1-2 Hz to 400 kHz, a range is not found in industry today. This ability makes it possible to reveal a great spectrum of failures including mechanical malfunctions such as imbalances or cracks in blades or shifts. This structural innovation is supported by signal processing advances and uses inexpensive micro-accelerometers and acoustical ceramics.

The system can use relatively low cost, commercially available PC's.

The application building process may be automated by analyzing the components of the object to be monitored (such as the bearings or gears, etc) rather than the machine as a whole and offers a high degree of diagnostic specificity.

The diagnostic monitoring system allows customers to monitor their machines remotely from down the hall or around the world. This important capability has impact on both economics as well as convenience, because remote monitoring greatly reduces the need for operators to oversee a process on-site, and frees them up to accomplish other job functions (in other company facilities if necessary).

The system provides an advantageous method for knowledge-based signal processing. This approach makes it possible to apply signal processing procedures in accordance with the actual obtained results and the mechanical structure of the monitored machine. Whereas typically, a human analyst looks at the results and decides which method(s) to use to understand what is happening, the present invention uses artificial intelligence rules contained in its system to automatically call the appropriate signal processing procedures.

The method of flexible data acquisition is a distinct advantage over current systems. Typical systems tune themselves to operating parameters just one time, and then remain fixed in any environment. The present system tunes itself automatically according to the actual current conditions. The length of the signal time series, the period between signals and filtering parameters are not only flexible but will change automatically to meet the environment's changing requirements.

The system provides for automatic customization of the database of potential equipment failures. Other systems have threshold values for typical pieces of equipment, usually recommended by the manufacturer or dictated by general standards. The present system automatically creates a base-line model describing the behavior of the monitored asset in base line conditions, and then relates the threshold values to the real conditions of the actual piece of equipment being monitored. The actual threshold values for any piece of equipment being monitored are calculated on-line.

The system automatically detects the diagnostics indicators specific to the mechanical structure of the monitored piece of equipment, and provides the dynamic analysis of their trends. The trend fundamental changes are recognized as monitored machine health symptoms. The system records a history of symptoms that characterize the dynamics of failure development.

A method of diagnostics pattern recognition that is used that can be categorized as a branch of fuzzy logic. A list of current symptoms is statistically compared with a pre-defined symptom list related to various failures that are typical for the monitored machine. As a result, a program produces a series of probabilities of pre-determined failures that represent the current situation. The system then looks at a trend of these probabilities and extrapolates. As the probabilities grow towards critical values the time to take corrective action can be evaluated with greater specificity.

What is claimed is:

1. A system for remote diagnosis of objects positioned in geographically diverse locations, the system comprising:
a plurality of data acquisition computers, each of said plurality of data acquisition computers being operatively connected for gathering data from corresponding sensors monitoring a corresponding object;
a diagnostic computer system remotely located from said plurality of data acquisition computers, said diagnostic computer system comprising:
a database for storing status data relating to the distributed objects, said status data being gathered by said plurality of data acquisition computers;
an expert system configured for performing signal processing to analyze said status data and identifying disorders of the distributed objects as a function of a correlation between said status data and data stored in said knowledge base; and
an alarm system for automatically generating an alarm upon identification of a disorder of one of the distributed objects; and
a server computer located remotely from the objects, said server computer being operatively connected to said diagnostic computer system for communication of data therewith, said server computer storing in its memory a knowledge base for storage of data relating to various types of distributed objects, and information relating to said diagnostic computer system.

2. The system of claim 1, wherein said expert system stores data acquisition rules identifying data acquisition parameters, said expert system being operatively connected to said plurality of data acquisition computers to automatedly cause data to be gathered from a monitored object in accordance with corresponding data acquisition parameters identified by a rule applicable to the monitored object.

3. The system of claim 1, wherein said expert system is configured to vary its signal processing according to signal processing results reflecting a current health status of a monitored distributed object, said expert system being configured to automatically vary such signal processing according to predetermined rules stored in the expert system.

4. The system of claim 1, wherein the knowledge base stores object-specific rules regulating data acquisition, signal processing, monitoring and system operation.

5. The system of claim 1, wherein the system for identifying disorders of the distributed objects calculates probabilities of predefined patterns of typical disorders as being a currently observed disorder.

6. The system of claim 1, wherein said knowledge base of said server includes information relating to a type of object, and wherein said diagnostic computer system stores Information relating to a specific object monitored by a corresponding data acquisition computer, wherein detection of a new pattern of failure is communication from said diagnostic computer system to said server for future use in diagnosis of remotely located objects.

7. The system of claim 1, wherein the diagnostic computer system relates to a current disorder pattern and a predefined disorder pattern stored in the knowledge base as points in multi-dimensional space.

8. The system of claim 7, wherein the diagnostic computer system provides a current disorder classification as a function of a distance between points representing typical disorders and a point representing the current disorder.

9. The system of claim 1, wherein the diagnostic computer system creates an online analytical model of probability trends for object disorders.

10. The system of claim 9, wherein the diagnostic computer system forecasts a time when corrective actions should be taken to correct a disorder of the monitored object by future extrapolation of said analytical model.

11. The system of claim 10, wherein a threshold for the extrapolation is defined by heuristic rules stored in the knowledge base.

12. The system of claim 1, wherein each monitored object is conceptually decomposed to a relatively small set of basic components.

13. The system of claim 12, wherein the conceptual decomposition relates to a type of distributed objects.

14. The system of claim 12, wherein the predetermined disorder patterns relate to the basic components.

15. The system of claim 1, wherein the system automatically adds to the knowledge base a new disorder pattern that does not correspond to a predetermined disorder pattern.

16. The system of claim 15, wherein the new disorder pattern is automatically related to all distributed objects of a related type.

17. The system of claim 1, wherein the knowledge base comprises:
a rule domains entity including a data acquisition rule domain, a signal processing rule domain, a system customization rule domain, a disorder recognition confidence rule domain, an archiving rule domain, a report generation rule domain, and a data transmission rule domain.

18. The system of claim 12, wherein the knowledge base stores threshold values relating to diagnostic parameters for each basic component, and a disorder pattern for each basic component.

19. The system of claim 1, wherein information relating to a specific distributed object, and diagnostic indicator disorder thresholds, are obtained automatically during a customization step before initiation of monitoring and diagnosis of the specific distributed object.

20. A method for remote diagnosis of distributed objects, the method comprising:
providing a data acquisition system for acquiring data from a first object during its operation, said data acquisition system acquiring data for certain operating parameters for said first object;
providing a database of disorder profiles for various objects including said first object, said database of disorder profiles comprising data for the certain operating parameters that is representative of a known disorder condition;
comparing data gathered from said system to the data of said disorder profiles to identify any disorder profile having a respective statistically significant correlation; and
identifying said first object as experiencing the known disorder condition corresponding to the corresponding disorder profile having a most statistically significant correlation.

21. The method of claim 20, further comprising adding to the database as a new disorder profile the data gathered from said data acquisition system for said first object if said data does not have a statistically significant correlation to any of said disorder profiles.

22. The method of claim 21, further comprising providing a second data acquisition system to acquire data from a second object during its operation, said second data acquisition system acquiring data for certain operating parameters for said second object;
whereby said new disorder profile is available for consideration of disorder of said second object.

23. A system for remote diagnosis of objects positioned in geographically diverse locations, the system comprising:
a plurality of data acquisition computers, each of said plurality of data acquisition computers being operatively connected for gathering data from a corresponding sensor monitoring a component of a corresponding object;
a server computer located remotely from the objects, said server computer being operatively connected to said plurality of data acquisition computers for communication of data therewith, said server computer storing in its memory a database of disorder profiles for various types of basic components of objects, each of said disorder profiles comprising data for the certain operating parameters that is representative of a known disorder condition;
a diagnostic computer system remotely located from said plurality of data acquisition computers, said diagnostic computer system being configured for:
comparing gathered data relating to said component to data of said disorder profiles corresponding to a similar basic component to identify any disorder profile having a respective statistically significant correlation; and
identifying said corresponding object as experiencing the known disorder condition corresponding to the disorder profile having the most statistically significant correlation.

24. The system of claim 23, wherein said diagnostic computer system is configured to add to the database as a new disorder profile for a respective basic component the data gathered from said component if said data does not have a statistically significant correlation to any of said disorder profiles.

25. A system for remote diagnosis of objects positioned in geographically diverse locations, the system comprising:
a plurality of data acquisition computers, each of said plurality of data acquisition computers being operatively connected for gathering data from a corresponding sensor monitoring a corresponding monitored object;
a plurality of diagnostic computers, each of said plurality of diagnostic computers being configured to:
compare data gathered from said corresponding monitored object to data of a pre-existing disorder profile for a similar object to identify a respective statistically significant correlation;
identify said corresponding monitored object as experiencing the known disorder condition if there is a statistically significant correlation; and
identify a new disorder condition of the corresponding monitored object that does not have a statistically significant correlation to the known disorder condition; and
a server computer located remotely from the objects, said server computer being operatively connected to said plurality of diagnostic computers for communication of data therewith, said server computer storing in its memory a database of disorder profiles for various objects, each of said disorder profiles comprising data for the certain operating parameters that is representative of a known disorder condition;
wherein each of said diagnostic computers is configured to add to the server's database as a new disorder profile for a respective object the data gathered from said corresponding monitored object that represents said new disorder condition if said data does not have a statistically significant correlation to any disorder profile of any known disorder condition;
whereby said new disorder profile is retained at said remotely located server and is accessible for diagnosis of disorders of similar objects at locations distinct from said corresponding monitored object.
